(19) United States
(12) Patent Application Publication
(10) Pub. No.: US 2009/0035657 A1
(43) Pub. Date: Feb. 5, 2009

(54) Electrode for Hybrid Energy Storage Device and Method of Making Same

(76) Inventors: Edward R. Buiel, New Castle, PA (US); Victor Eshkenazi, Vaughan (CA); Leonid Rabinovich, Thornhill (CA); Wei Sun, New Castle, PA (US); Vladimir Vichnyakov, Newmarket (CA); Adam J. Swiecki, Milton (CA)

Correspondence Address: CAHN & SAMUELS LLP, 1100 17th STREET NW, SUITE 401, WASHINGTON, DC, 20036, US

(21) Appl. No.: 11/875,108

(22) Filed: Oct. 19, 2007

Related U.S. Application Data
(60) Provisional application No. 60/853,436, filed on Oct. 23, 2006.

(51) Int. Cl. H01M 4/64; B05D 5/12

(52) U.S. Cl. 429/211; 427/58

(57) ABSTRACT

An electrode for a hybrid energy storage device includes a current collector; an active material adhered to and in electrical contact with at least one surface of the current collector; and a tab element, wherein the thickness of the tab element is greater than the thickness of the current collector.

### I. RELATED APPLICATIONS

This application claims priority of U.S. Ser. No. 60/853,436 filed on Oct. 23, 2006, the entirety of which is incorporated by reference.

### II. FIELD OF INVENTION

The present invention relates to an electrode comprising a current collector and tab element for a hybrid energy storage device and to a method of making such an electrode.

### III. BACKGROUND INVENTION

Hybrid energy storage devices, also known as asymmetric supercapacitors or hybrid battery/supercapacitors, combine battery electrodes and supercapacitor electrodes to produce devices having a unique set of characteristics including cycle life, power density, energy capacity, fast recharge capability, and a wide range of temperature operability. Hybrid lead-carbon energy storage devices employ lead-acid battery positive electrodes and supercapacitor negative electrodes. See, for example, U.S. Pat. Nos. 6,466,429; 6,628,504; 6,706,079; 7,006,346; and 7,110,242.

In making an electrode, it is conventional to stamp a current collector from a sheet or roll of foil. Using this practice, a current collector has a tab element that is an integral part of the stamped article. The size of the current collector may vary from energy storage device to energy storage device, in terms of at least one of height, width, or thickness of the sheet or foil to be used. The placement of a tab element extending from a side of the current collector, for example from a top edge of the current collector, will also vary depending on the design of the energy storage device. Accordingly, conventional processes require specific tooling for each current collector design, depending on the nature of the energy storage device. In addition, conventional stamping of a current collector element from a sheet or roll of foil creates waste.

Further, the robustness of the tab element is dependent upon the nature of the sheet or foil material, particularly its thickness. Thus, in a conventional electrode, the current collector must be sized to the thickness of the tab element. This causes an undesirable increase in the thickness of the electrode and decreases the amount of active material that may be used in a hybrid energy storage device, thereby decreasing the capacity of the device.

The inventors have proven that an electrode can be made such that the tab element is thicker than the current collector. As a result, the tab element is stronger and more resilient to mechanical stresses than the current collector, for example, during at least one of a cast-on strap operation, plate brushing, and insertion into a housing for a hybrid energy storage device. The tab element can carry more current than the body of the current collector. The process according to the present invention also substantially eliminates waste and the need for separate stamping tools for each current collector design.

### IV. SUMMARY OF INVENTION

It is an object of the present invention to provide an electrode for a hybrid energy storage device in which the tab element is thicker than the current collector.

It is another object of the present invention to provide an electrode having a tab element having the strength to support at least one of a cast-on strap operation, plate brushing, and insertion into a housing for a hybrid energy storage device.

It is an advantage of the present invention that the making of a current collector minimizes or eliminates waste.

It is another advantage of the present invention to minimize or eliminate the need for preparing costly stamping tools for different current collector designs.

It is yet another advantage of the present invention that the tab element can carry more current than the body of the current collector.

The above objects and advantages are satisfied by an electrode for use in a hybrid energy storage device comprising a current collector; an active material adhered to and in electrical contact with at least one surface of the current collector; and a tab element extending from a side of the electrode, for example, above a top edge of the current collector. The thickness of the tab element is greater than the thickness of the current collector.

As used herein “substantially”, “generally”, “relatively”, “approximately”, and “about” are relative modifiers intended to indicate permissible variation from the characteristic so modified. It is not intended to be limited to the absolute value or characteristic which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### V. BRIEF DESCRIPTION OF THE DRAWINGS

FIG. 1 illustrates a prior art method of stamping a current collector and integral tab element.

FIG. 2 illustrates a current collector on which a tab element may be positioned in various positions.

FIG. 3A illustrates cutting a current collector according to an embodiment of the present invention.

FIG. 3B illustrates positioning and cutting a tab element according to an embodiment of the present invention.

FIG. 4 is a side view of a tab element according to a first embodiment of the present invention.

FIG. 5 is a side view of tab element according to a second embodiment of the present invention.

### VI. DETAILED DESCRIPTION OF THE INVENTION

FIGS. 1-5 illustrate an electrode comprising a current collector and tab element for a hybrid energy storage device and a method of making such an electrode according to the present invention. The electrode may be at least one of a positive electrode or a negative electrode. However, for the discussion below, the embodiment for a negative electrode will be discussed.

A negative electrode for use in a hybrid energy storage device comprises a current collector, a corrosion-resistant coating, and an electrochemically active material. The negative electrode also comprises a tab element extending from a side of the electrode, for example, from a top edge of the current collector.

According to the present invention, the thickness of the tab element is greater than the thickness of the current collector. For example, the thickness of the tab element may be about 0.1 mm to about 10 mm. In general, the thickness of the tab element depends on the size of the hybrid energy storage device. For a device with less than 150 Ampere-hours (Ah), the thickness of the tab element may be about 0.15 mm to about 1 mm. For other devices needing about 1000 Ah (uninterruptible power source or UPS) to about 3000 Ah (submarine), the thickness of the tab element may be up to about 3 mm. The thickness of the current collector (e.g., copper foil) may be about 75 microns to about 0.5 mm.

FIG. 1 illustrates a prior art method of manufacturing a current collector element for a negative electrode of a hybrid energy storage device. Current collector 5 has a tab element 10 integrally formed therewith. The current collector 5 and tab element 10 are stamped from a sheet or roll of highly conductive material.

However, scrap pieces 15 and 20 are created which must be disposed of. Additional scrap may also be created when the current collector 5 is manufactured if the width or height of the sheet or roll of conductive material is greater than the width or height of the current collector. Accordingly, a significant amount of waste material may be created in any large-scale manufacturing process. Moreover, for each design of a current collector in which the tab element is located differently, an additional stamping tool must be made with the concomitant costs thereof.

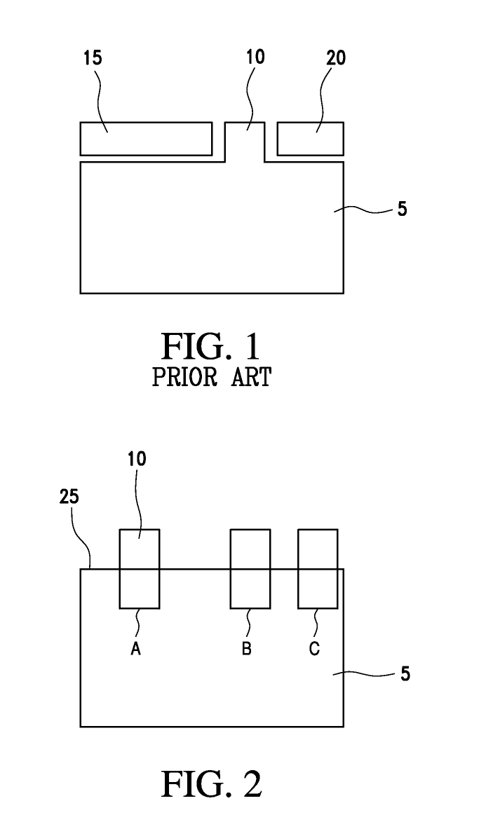

FIG. 2 illustrates a current collector 5 and tab element 10 extending above a top edge 25 of the current collector. Tab element 10 may be placed anywhere along the current collector 5, such as is shown in position A, position B, or position C. According to the present invention, the tab element 10 is welded to the current collector 5 at a predetermined position on both surfaces of the current collector 5. The thickness of tab element 10 is greater than the thickness of current collector 5.

The current collector 5 comprises a conductive material. For example, the current collector may comprise a metallic material such as beryllium, bronze, lead, leaded commercial bronze, copper, copper alloy, silver, gold, titanium, aluminum, aluminum alloys, iron, steel, magnesium, stainless steel, nickel, mixtures thereof, or alloys thereof. Preferably, the current collector comprises copper or a copper alloy. The material of the current collector may be made from a mesh material (e.g., copper mesh).

The current collector may comprise any conductive material having a conductivity greater than about 1.0×10⁵ siemens/m. If the material exhibits anisotropic conduction, it should exhibit a conductivity greater than about 1.0×10⁵ siemens/m in any direction. The tab element 10 may comprise the same material or a different material than the current collector 5.

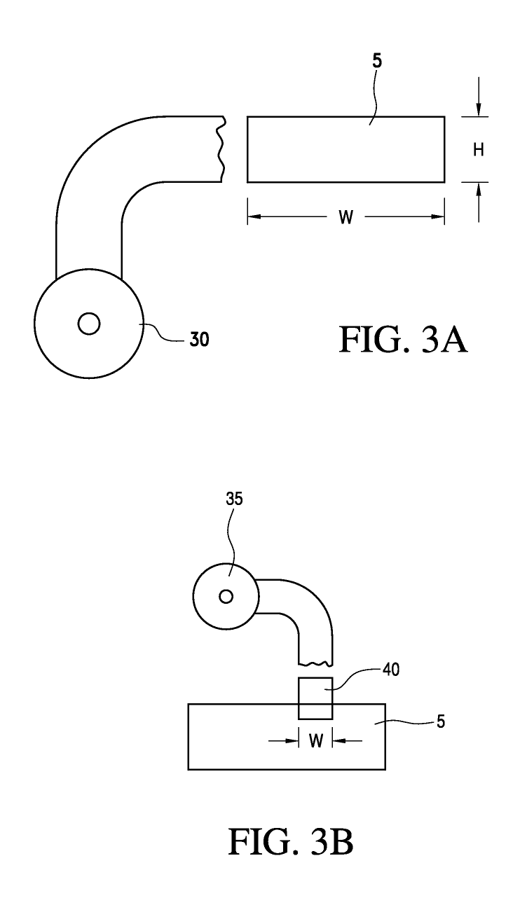

FIGS. 3A-3B illustrate a method of making a current collector and tab element of an electrode according to the present invention.

As illustrated in FIG. 3A, a first roll 30 comprising the conductive material for forming the current collector 5 is unrolled and a strip corresponding to current collector 5 is cut having a width W and a height H.

Accordingly, the height H corresponds to the width of the current collector material from roll 30 and the width W corresponds to the length of any individual current collector 5 that is cut from roll 30 using ordinary cutting tools well known in the art of metalworking. Because the length of each piece of current collector material that is cut from a sheet or roll is equal to the width of the current collector to be manufactured, waste such as elements 15 and 20 of FIG. 1 is substantially minimized or eliminated.

As illustrated in FIG. 3B, a second roll 35 comprising material for forming the tab element 10 is unrolled and at least one strip 40 is cut, which will form tab element 10. The at least one strip 40 is passed across at least one surface of current collector 5.

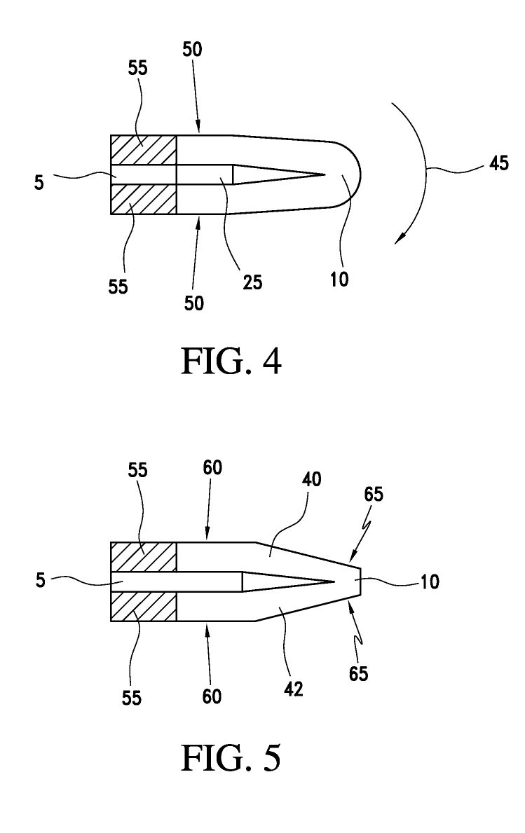

The at least one strip 40 has a width W corresponding to the width of the tab element 10 to be manufactured. The determination as to whether the at least one strip 40 will comprise one strip or two strips is made depending on the details of the tab element 10 to be manufactured, as discussed below with respect to FIGS. 4-5. The at least one strip 40 may be positioned along the current collector at a determined position (for example, position A, B, or C as illustrated in FIG. 2) to form tab element 10.

FIG. 4 illustrates a specific embodiment of a tab element 10 according to the present invention in which a strip of material 40 to form a tab element is folded over and welded to both surfaces of the current collector 5 in a predetermined position.

In this embodiment, a single predetermined length of a strip 40 is cut using ordinary cutting equipment, and that length of the at least one strip 40 is folded around an edge of the current collector 5, as shown by arrow 45. The folded strip is welded at a designated position along an edge, for example top edge 25, of the current collector 5, as shown by arrows 50. Typical welding processes that may be employed include, but are not limited to, resistance welding, laser welding, or ultrasonic welding.

At least one of a corrosion-resistant conductive coating or an electrochemically active material 55 is adhered to at least one surface of current collector 5. For a negative electrode, the active material may comprise activated carbon and a corrosion-resistant coating may comprise graphite impregnated with a non-polymeric substance. For a positive electrode, the active material may comprise lead oxide.

FIG. 5 illustrates an alternative embodiment of a tab element 10 according to the present invention in which two strips of material to form a tab element are passed across respective surfaces of the current collector 5 in a predetermined position, are welded together, and are also welded to the current collector 5 to form the tab element 10.

In this embodiment, two strips 40, 42 are used to form the tab element 10. The two strips are cut into predetermined lengths. Each of the two strips 40, 42 is welded to an opposite side of the current collector 5 as shown by arrows 60, and they are also welded to one another, as shown by arrows 65.

At least one of a corrosion-resistant conductive coating or an electrochemically active material 55 is adhered to at least one surface of current collector 5. As shown in FIGS. 4-5, the thickness of the tab element 32 is greater than the thickness of the current collector 30.

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

What is claimed is:

1. An electrode for a hybrid energy storage device, comprising:
a current collector;
a tab element extending from a side of the electrode, wherein the thickness of the tab element is greater than the thickness of the current collector; and
an active material adhered to and in electrical contact with at least one surface of the current collector.

2. The electrode according to claim 1, wherein the electrode comprises a negative electrode and the current collector comprises copper or copper alloy.

3. The electrode according to claim 2, wherein the active material comprises activated carbon.

4. The electrode according to claim 2, wherein the tab element comprises copper.

5. The electrode according to claim 2, wherein the tab element comprises steel.

6. The electrode according to claim 1, wherein the thickness of the tab element is about 0.1 mm to about 10 mm.

7. The electrode according to claim 6, wherein the thickness of the current collector is about 75 microns to about 0.5 mm.

8. An electrode according to claim 1, wherein the electrode comprises a positive electrode and the current collector comprises lead and the active material comprises lead oxide.

9. A method of making an electrode for a hybrid energy storage device, comprising:
cutting a current collector from a first sheet or roll of conductive material, wherein a height of the current collector equals the width of the first sheet or roll and wherein a width of the current collector equals the length cut from the first sheet or roll;
cutting at least one strip from a second sheet or roll of material for a tab element, wherein a width of the second sheet or roll equals a width of the tab element;
positioning the at least one strip where the tab element is to be affixed; and
attaching the at least one strip to the current collector, thereby forming a tab element extending from a side of the current collector,
wherein the thickness of the tab element is greater than the thickness of the current collector.

10. A method according to claim 9, further comprising applying a corrosion-resistant conductive coating to at least one side of the current collector.

11. A method according to claim 9, further comprising applying an active material to at least one side of the current collector.

12. The method according to claim 9, further comprising folding the at least one strip over an edge of the current collector prior to said attaching.

13. The method according to claim 9, further comprising:
cutting two strips from the second sheet or roll;
positioning the two strips so that each strip is on an opposite side of the current collector; and
attaching the two strips to the current collector and to each other.

14. The method according to claim 9, wherein the electrode comprises a negative electrode and the current collector comprises copper or copper alloy.

15. The method according to claim 14, wherein the tab element comprises copper.

16. The method according to claim 14, wherein the tab element comprises steel.

17. The method according to claim 14, wherein the thickness of the tab element is about 0.1 mm to about 10 mm.

18. The method according to claim 17, wherein the thickness of the current collector is about 75 microns to about 0.5 mm.

19. The method according to claim 9, wherein the electrode comprises a positive electrode and the current collector comprises lead.
